(19) United States
(12) Patent Application Publication
(10) Pub. No.: US 2021/0222095 A1
(43) Pub. Date: Jul. 22, 2021

(54) ORGANIC SKIN CLEANSING SOAP AND DISPENSER

(71) Applicant: Matthew Williams, Sacramento, CA (US)

(72) Inventor: Matthew Williams, Sacramento, CA (US)

(21) Appl. No.: 17/155,514

(22) Filed: Jan. 22, 2021

Related U.S. Application Data
(60) Provisional application No. 62/964,192, filed on Jan. 22, 2020.

(51) Int. Cl. C11D 13/10; A47K 5/08

(52) U.S. Cl. CPC C11D 13/10; A47K 5/08

(57) ABSTRACT

A combination organic skin cleansing black soap formulation in a container with an internal twisting mechanism at the base is disclosed. This combination works together to help preserve and protect the soap by incrementally dispensing the soap for use and storage following use, respectively. The combination device can be used to remove makeup, reduce redness, tighten skin, reduce blemishes, soften the skin, exfoliate, and improve the overall health of the skin. The soap ingredients are processed and mixed. Thereafter, the soap mixture is placed into the container and left to set. After hardening, the twisting mechanism can thereafter selectively expose the soap for use or retract for safekeeping.

### BACKGROUND

This application claims the benefit of prior filed U.S. provisional application 62/964,192, filed Jan. 22, 2020, the contents of which are incorporated herein by reference.

### 1. FIELD OF THE INVENTION

The invention relates generally to soap. Specifically, the invention relates an organic skin cleansing soap having a particular composition and dispensed from a device that maintains the integrity of the soap over time and prevents the dis-solution thereof despite repeated use.

### 2. BACKGROUND

There are several product solutions for skin cleansing and makeup removal. Some of these known solutions attempt to remove blemishes, exfoliate, tighten, soften, and nourish the skin. Even so, these solutions fail to meet the needs of users because of a growing demand for natural and organic products, as opposed to increasingly harsh, abrasive, and drying outcomes of enhanced performance cleansing products. Other known solutions attempt to remove make-up and cleanse the skin, but these solutions are similarly unable to meet the needs of users owing to the multiple and complementary products needed to complete a single make-up removal session or job. Still, other solutions seek to offer all-natural skin cleansing soaps. Yet, these solutions also fail to meet industry needs because of a lack of portability, ease of use, inferior quality, and generally falling short on customer expectations for expected use and purpose. Furthermore, many products are not entirely organic, despite what is inferred by promotional materials. Some known solutions which attempt to blend black soap and oils fail owing to an inability to retain the mixed oils which can bleed into surrounding packaging and containers.

The composition of conventional organic “black soap” deforms and softens in damp, wet, or, even, excessively humid conditions. Furthermore, prolonged storage in extreme conditions (hot, cold, high, low humidity) may lead to discoloring of the soap and creating a belief that it is not any longer suitable or even desirable to use. In addition, the raw product is, like most raw soap products, bulky and hard to transport. Also, generic packaging containers lack aesthetics and convenience for users. Another issue with conventional black soap is that it starts to rapidly melt when the soap comes into contact with water. This melting action greatly reducing the amount of use a person can get from a single bar. Also, one of the side effects of black soap is that it dries the skin, which may cause some additional discomfort. A need exists for an organic skin cleanser that overcomes these shortcomings of conventional black soap.

### SUMMARY OF THE INVENTION

The present invention is a combination black soap formulation and packaging that overcome the identified shortcomings of traditional back soap. Disclosed is an organic skin cleansing soap provided in a storage/use container equipped with a twisting mechanism to incrementally advance the soap from the container as it is applied and used. The twisting mechanism at the base of the container allows for both ease of application of the soap and to maintain the soap structure for full usage until the source of the soap is spent. The natural formula is made up of the following base ingredients: raw black soap, coconut oil, essential oils, and shea butter. In addition, there is a specialized process disclosed for combining the ingredients. All ingredients being thoroughly mixed and piped into the container for hardening.

The lightweight and compact design of the container is easily transported in a makeup bag or purse, etc. The twisting mechanism eases the task of applying the soap and provides better and more economical usage of the black soap owing to incremental advancement thereof. The cylindrical container may be produced in 1 and 2.5-ounce sizes for different options. This organic soap and container is light, portable, of high quality, with superior skin penetration properties.

The base ingredients, noted previously, may also be supplemented by one or more of the following: Turmeric; medicinal honey; charcoal; different blends of essential oils; and kokum butter. The base formula improves on the drying of the skin by raw black soap. These options provide for more enhanced effects tailored to a specific skin condition.

The disclosed invention achieves the following objects: (1) Fully organic skin cleansing solution. (2) Twisting the base in a clockwise motion exposes the soap for use, while the counter-clockwise movement retracts for storage. (3) The bar maintains its structure, despite occasional exposure/application to wet skin, with no leaking of mixed/added oils.

Similarly, the associated cleansing method: (1) The bar reduces the harsh drying of the skin caused by raw black soap. (2) Calms, smooths, and rejuvenates the skin. (3) The bar offers many skin cleansing benefits in one product. (4) It is a skin cleanser useful for all skin types. (5) Offers superior skin penetrating properties. (6) Is a natural skin cleanser for effectively and efficiently removing makeup. And, lastly, (7) the combination naturally tones, tightens and exfoliates the skin. The disclosed process used herein enables the soap to retain the oils within the dispenser and upon application thereof in use.

The disclosed dispensing device is structurally different from other known devices or solutions and achieves the following objects: (1) A functional and aesthetically packaged, portable, and user-friendly product. (2) Maintains the soap structure throughout use and can withstand wet, humid, or warm conditions. (3) Cylindrical, screw top, capped tube. The device has a safety cap and a screw-on lid for ultimate protection from the elements. The end cap snaps into the grooves of the base, enclosing and activating the twisting mechanism. The dispenser is intended to receive adequately heated and blended soap, which is then piped directly into the package.

The combination of the elements mentioned provides a long-lasting, deep pore cleansing, organic, skin-nourishing product. The appealing features of this natural skin cleansing soap would be its all-natural ingredients, novel formula, effectiveness, convenience, timesaving, portability, and ease of application. This formula is applicable for people of all ages and skin types, including oily, dry and combination skin. This skin cleanser improves the look, feel, and health of the skin. This product will gently soften, tone, and condition a person's skin, as well as help to avoid breakouts, acne, and redness. Furthermore, it would rejuvenate the skin for a younger, healthier appearance, which could also contribute to greater self-confidence and a better physical appearance.

Notably, this formula, with regular use on the skin, offers superior healing properties. This black soap formula would exfoliate, tone, and tighten the skin, without the dry feeling. Also, the packaging makes it portable, easy to use and prolongs the shelf life of the formulated black soap.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The organic skin cleansing soap and dispenser may, however, be embodied in many different forms and should not be construed as being limited to the embodiments set forth herein; rather, these embodiments are provided by way of illustration only and so that this disclosure will be thorough, complete, and fully convey understanding to those skilled in the art.

### BRIEF DESCRIPTION OF THE DRAWINGS

FIG. 1.—is an exploded view of features of a soap dispenser in accord with the present invention.

FIG. 2—is an assembled dispenser showing internal structure of the dispenser.

### DETAILED DESCRIPTION

The present invention is directed to a combination organic skin cleansing soap and associated twist type incremental dispenser. The invention is made up of the following components: a formulated black soap bar contained within a container equipped with a twisting incremental advancing mechanism, cap, and cover.

In the preferred embodiment, the organic skin cleansing soap process begins by cutting up the desired amount of raw black soap into small pieces, preferably about 10 mm×10 mm×10 mm. These pieces are then placed into a large soap melter and set to a low temperature of about 180 F. Next, add the correct ratio, of about 0.5 oz.:8.0 oz (1 part to 16 parts) of coconut oil to the diced soap respectively. The black soap and coconut oil are gently mixed in the melter at a temperature preferably between about 80 and 180 F until it becomes creamy in appearance and texture using a mixer on a drill set at a mix speed of about 60-100 rpm.

The correct ratio of natural body butter and fractionated coconut oil, of about 0.5 oz:0.5 oz respectively, is melted slowly at an appropriate temperature of between 80 F and 100 F in a separate melting pot. While mixing the black soap and coconut oil in the primary melter, the melted body butter and coconut oil is poured, and thoroughly mixed, into the mixture of black soap and coconut oil at a temperature range of about 80 to 100 F. After this, the essential oils, for example, Tea Tree, Lavender, and/or Rosemary are added, completing the base formula for the organic skin cleansing soap. The amount of essential oil used is about 15 ml. in the above recited 8 oz. combination.

At this point, there may be a possible insertion of optional ingredients for added benefits and can include a variety of products. For example, enhancing the base formula with; Turmeric, Medicinal Honey, or Charcoal. Notably, the process of melting the natural butter and coconut oil is when the addition of any of the above ingredients in an amount of about 15 mil to 0.5 oz. would preferably occur. Therefore, dissolve the natural butter, and add the desired optional element(s). This combination is mixed separately, then added to the black soap and coconut oil mixture already blended in the melter, and gently mixed again.

This next step involves a piping machine placed atop of the melter. The machine fills the containers/dispensers 10 by pulling the soap, under either vacuum, or positive pressure, from the vessel and pumping it through a piping device. The dispenser 10 casings for 1 or 2.5 oz portions are then placed on a table upside down, i.e., receiving orientation, with the bottoms 26 removed. The piping machine fills the container 10 from the removable cap 12 to the base 14. The temperature remains constant with periodic mixing of the ingredients in between piping.

The soap combination is then left to harden in the dispensing container. After the soap has set, the bottom twisting end cap 26 of the casing is attached, enabling the internal twisting and lifting mechanism 28 to incrementally dispense the final product 30 from container 10. The finished product is now ready for use.

Notably, the heating and mixing of the ingredients at the correct temperature are necessary to the success of the formulation. The proper temperature allows the elements to bond and is workable for the piping/pumping process. The formulated black soap reduces the excessive dryness associated with conventional black soap.

A suitable melter used to melt the soap may be one originally for candle wax melting, and the piping device may originally be for baking applications, i.e., baking batter pumping, or even a turkey baster. For small experimental batches of soap, a typical kitchen sized double boiler pan system can be used, i.e., a soap melt/mix small pan contained within a larger pan, suspending the smaller pan in heated water. The melted mixture is then transferred to, for example, a piping bag, for depositing into the soap dispensers.

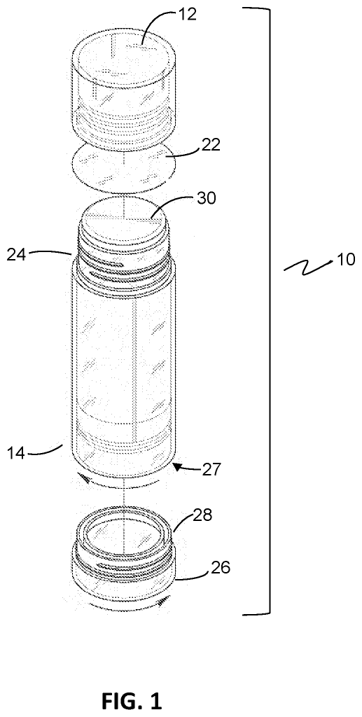

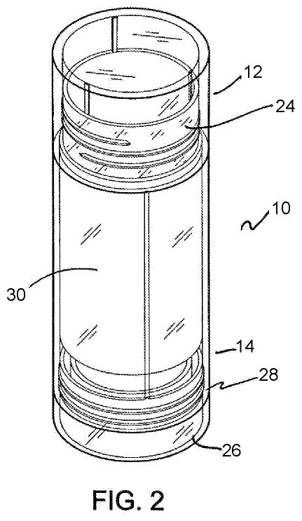

FIG. 1 illustrates an exploded view of the organic skin cleanser in its container 10 with all working parts. FIG. 2 is assembled dispenser showing internal structure thereof.

The top section highlights the covering mechanism for the container which includes the liner/seal/safety cap 22. The container has a screw-on cover 12 and a safety cap 22 for the soap. From the top, we have the screw-on cover followed by the safety cap. Secondly, the mid-section of the drawing shows the soap 30 within the container. The soap 30 is piped into the casing 10 from the bottom or base end 14, filling the dispenser progressively from the cap to the base. The base of the soap sits on top of the end cap/screwing mechanism 26/28. FIG. 1 shows the end cap/screwing mechanism 26/28 for the soap. The end cap 26 snaps into the casing internal grooves 27, enclosing the soap 30, and enabling the screwing device 26/28 to advance the soap 30 outside the container 10 for use.

The dispenser is preferably made of a suitable metal or plastic, or combination thereof, that can accommodate the heat of the liquid soap during the filling process and, thereafter, can be durable and resilient in use and carrying. The container maintains the shape of the soap for the duration of its useful life, and protects the soap from environmental contaminants, dust, excessive heat, moisture, etc.

For the associated method of cleansing skin: execution of the following core steps is followed: Remove screw top 12 and thin protective cover 22. Then, in a clockwise motion, twist the bottom 26 of the container 10 to expose the soap 30. Wet your face and hands, then lather your wet palms by rubbing the exposed soap onto the wet palms. Apply to face and rinse after the skin is thoroughly washed. Finally, twist the soap back into the container and screw-on cap 12. Ultimately, after these steps, you will achieve a deep cleanse, exfoliating the pores and removing impurities from your skin without that dry feeling associated with conventional raw black soap. Furthermore, a storage container 10 that allows full usage of the bar, adding aesthetics, ease of use, and portability. On average, a 2.5 oz soap bar in the dispenser disclosed herein lasts at least as long, if not longer, than a single unwrapped black soap bar.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

I claim:

1. A combination of a formulated soap and dispenser thereof, comprising:
a first mixture of raw black soap and coconut oil in a ratio of 16:1 combined and melted at a temperature of about 180 F and mixed until homogenous, and then further combined in a 16:1 ratio with a 1:1 mixed ratio of a second mixture of natural body butter and fractionated coconut oil to the mixture, said second mixture already prepared at a mixing temperature of between 80 and 100 F, and thereafter mixing said first and second mixtures at a mix temperature of between 80 and 100 F to create a third mixture, thereafter allowing said third mixture to cool and be placed within a tube dispenser completely containing the third mixture with an enclosed top, said tube dispenser being capable of incrementally exposing said third mixture when said third mixture is deployed and used as soap.

2. A combination as in claim 1, further comprising:
a fourth mixture of essential oils selected from the group consisting of tea tree oil, lavender, and/or rosemary, combined into said third mixture in a ratio of 15 ml to a 10 oz preparation of said third mixture.

3. A combination as in claim 2, further comprising:
a fifth mixture added to said third mixture selected from the group consisting of turmeric, medicinal honey, and/or charcoal in a ratio of 15 ml to a 10 oz preparation of said third mixture.

4. A method of cleansing damp skin using the soap recited in claim 1, wherein:
a user wets their face and palms using water, applies soap via the dispenser to their palms, creates a lather of soap and water on their palms, applies the lather to their face using a scrubbing motion, and, thereafter, rinses the soap from their face and hands.
